(19) United States
(12) Patent Application Publication
(10) Pub. No.: US 2020/0406290 A1
(43) Pub. Date: Dec. 31, 2020

(54) COMPOSITE FILM FOR A MATERIAL DISPENSER

(71) Applicant: NORDSON CORPORATION, WESTLAKE, OH (US)

(72) Inventors: Charles M. FREY, Sr., Groton, CT (US); Robert W. Springhorn, Cream Ridge, NJ (US)

(21) Appl. No.: 16/976,824

(22) PCT Filed: Feb. 27, 2019
(86) PCT No.: PCT/US2019/019732

§ 371 Date: Aug. 31, 2020

Related U.S. Application Data
(60) Provisional application No. 62/637,292, filed on Mar. 1, 2018.

(51) Int. Cl. B05C 17/005; B32B 15/085; B32B 15/20; B32B 27/08; B32B 27/32; B32B 27/40; B32B 7/12; B32B 1/08; B05C 17/015; B29C 45/14

(52) U.S. Cl. CPC B05C 17/00583; B29L 2031/715; B32B 15/20; B32B 27/08; B32B 27/32; B32B 27/40; B32B 7/12; B32B 1/08; B05C 17/015; B05C 17/00586; B05C 17/00553; B29C 45/14598; B32B 2250/40; B32B 2250/05; B32B 2439/46; B32B 2307/7244; B32B 15/085

(57) ABSTRACT

An apparatus for dispensing a flowable material is disclosed herein. The apparatus includes at least one bag. The at least one bag includes an inner layer that is a coextruded film and that defines an interior of the at least one bag configured to contain the flowable material. The at least one bag further includes an outer layer that defines an exterior of the at least one bag, and at least one intermediate layer disposed between the inner and outer layers. The apparatus also includes a face plate having an outlet configured to be placed in fluid communication with the interior of the at least one bag, wherein the flowable material is configured to flow from the interior of the at least one bag to be dispensed from the outlet of the face plate.

### CROSS REFERENCE TO RELATED APPLICATIONS

This application is a National Stage Application of International Patent App. No. PCT/US2019/019732, filed Feb. 27, 2019, which claims the benefit of U.S. Provisional Patent App. No. 62/637,292, filed Mar. 1, 2018, the entire disclosures of both of which are hereby incorporated by reference as if set forth in their entirety herein.

### TECHNICAL FIELD

The present invention relates generally to composite films for bags of material dispensers, and more particularly relates to a layered structure for the composite film.

### BACKGROUND

The present invention relates to component packs for the dispensing of various components via a dispenser, particularly to component packs employing a pair of film bags containing flowable compositions which are to be mixed when ejected from the dispenser, and more particularly to a component delivery system employing the pair of film bags.

Various compositions are packaged in tubular cartridges or bags for use in caulking guns and other types of dispensing mechanisms. Typically, such cartridges/bags have employed tubes of plastic, or coated or laminated paperboard, in single or multi-layer films. Existing cartridges/bags have been prone to leakage as a result of poor sealing characteristics. Further, existing cartridges/bags have problems related to permeability of light, oxygen, and/or moisture which may penetrate into the cartridges/bags and damage the materials stored therein. Still further, some existing cartridges/bags have issues with toughness and chemical compatibility. All of these issues associated with existing cartridges/bags can compromise the shelf life of materials.

Accordingly, there exists a need for an improved cartridge/bag that addresses these issues.

### SUMMARY

Disclosed herein are dispensers for dispensing a flowable material. In one embodiment, the dispenser includes at least one bag. The at least one bag includes an inner layer that is a coextruded film that defines an interior of the at least one bag configured to contain the flowable material. The at least one bag further includes an outer layer that defines an exterior of the at least one bag, and at least one intermediate layer disposed between the inner and outer layers. The apparatus also includes a face plate having an outlet configured to be placed in fluid communication with the interior of the at least one bag, where the flowable material is configured to flow from the interior of the at least one bag to be dispensed from the outlet of the face plate.

In another embodiment, a method for producing the at least one bag of the dispenser is disclosed. The method includes coextruding a coextruded film and providing at least one intermediate layer between an outer layer and the coextruded film. The method also includes forming the at least one bag out of the outer layer, the at least one intermediate layer, and the coextruded film such that the outer layer defines an exterior of the at least one bag and the coextruded film is an inner layer that defines an interior of the at least one bag.

Various additional features and advantages of this invention will become apparent to those of ordinary skill in the art upon review of the following detailed description of the illustrative embodiments taken in conjunction with the accompanying drawings.

### BRIEF DESCRIPTION OF DRAWINGS

The following detailed description is better understood when read in conjunction with the appended drawings. For the purposes of illustration, examples are shown in the drawings; however, the subject matter is not limited to the specific elements and instrumentalities disclosed. In the drawings:

FIG. 1 illustrates a cross-sectional view of an exemplary dispenser in accordance with aspects of the invention;

FIG. 2 illustrates a schematic cross-sectional view of a composite film in accordance with aspects of the invention;

FIG. 3 illustrates a view of another exemplary dispenser in accordance with aspects of the invention;

FIG. 4 illustrates an alternate view of the exemplary dispenser of FIG. 3;

FIG. 5 illustrates a view of yet another exemplary dispenser in accordance with aspects of the invention;

FIG. 6 illustrates an alternate view of the exemplary dispenser of FIG. 5;

FIG. 7 illustrates shuttles of the exemplary dispenser of FIG. 5;

FIG. 8 illustrates a view of another exemplary dispenser in accordance with aspects of the invention;

FIG. 9 illustrates a cross-sectional view of the dispenser of FIG. 8;

FIG. 10 illustrates another cross-sectional view of the dispenser of FIG. 8;

FIG. 11 illustrates an exemplary process for producing a bag in accordance with aspects of the invention;

FIG. 12 illustrates a schematic cross-sectional view of a mold assembly in accordance with aspects of the disclosure; and

FIG. 13 illustrates a schematic cross-sectional view of another mold assembly in accordance with aspects of the disclosure.

### DETAILED DESCRIPTION OF ILLUSTRATIVE EMBODIMENTS

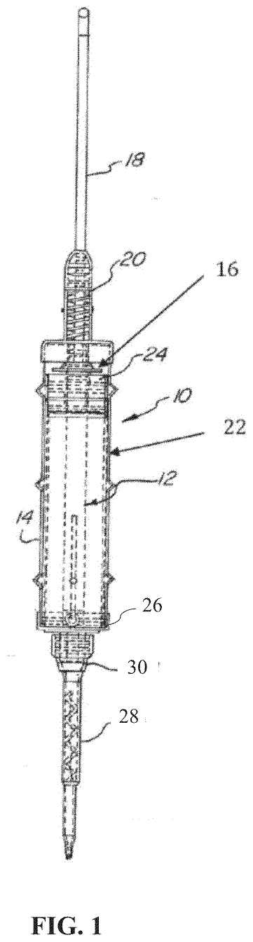

FIG. 1 illustrates a cross-sectional view of an exemplary dispenser 10 in accordance with aspects of the invention. The dispenser 10 may include a bag 12 containing at least one material (e.g., sealant, adhesive, protectant, paint, coating materials, foams, etc.). The dispenser 10 may be a caulking gun that may include an arcuate housing 14, an end plate 16, a piston/rod 18, an actuator assembly 20, a sleeve 22, a shuttle 24, a face plate 26, and/or a nozzle 28. The face plate 26 may have an outlet 30 that may be in fluid communication with an interior of the bag 12. For example, the bag 12 may have an outlet (not shown), aligned with the outlet 30 of the face plate 26, through which the material may flow. The outlet 30 of the face plate 26 may be in fluid communication with the nozzle 28.

The bag 12 may be disposed in the arcuate housing 14, and may be supported in the sleeve 22. The actuator assembly 20 may initiate movement of the piston/rod 18 to press the end plate 16 against the shuttle 24 and thereby cause the shuttle 24 to move the within the sleeve 22. The movement of the shuttle 24 within the sleeve 22 may squeeze the bag 12 between the shuttle 24 and the face plate 26, which may cause the material from the interior of the bag 12 to be dispensed from the outlet 30 of the face plate 26 and through the nozzle 28 for use.

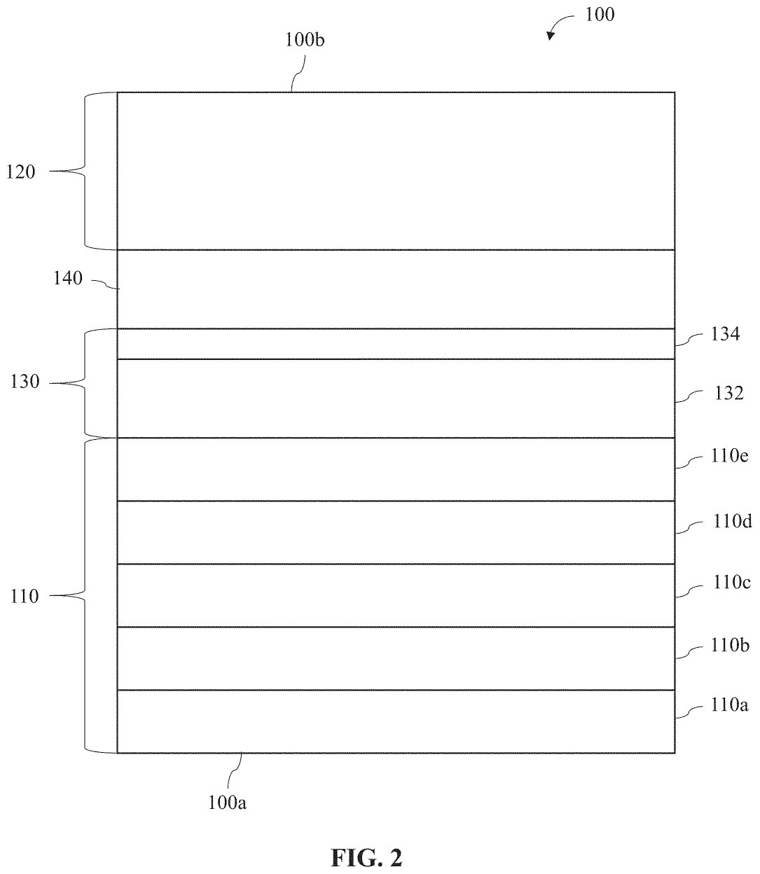

FIG. 2 illustrates a schematic cross-sectional view of a composite film 100 in accordance with aspects of the invention. The composite film 100 may be used to form the bag 12 (as described above), or a bag associated with any of the other dispensers described and/or incorporated herein. In FIG. 2, the thickness of the composite film 100 is exaggerated (relative to the width of the composite film 100) to more clearly illustrate the material layers (described below) that may comprise the composite film 100.

The composite film 100 may include an inner layer 110. The inner layer 110 may define a boundary of an interior of the bag 12 formed from the composite film 100. The interior of the bag 12 may contain the material therein. The inner layer 110 may have a thickness between 2.85 mm and 3.15 mm. For example, the thickness of the inner layer 110 may be 3.00 mm. The composite film 100 may further include an outer layer 120. The outer layer 120 may define an exterior of the bag 12 formed from the composite film 100. The outer layer 120 may have a thickness between 1.42 mm and 1.58 mm. For example, the thickness of the outer layer 120 may be 1.50 mm. The composite film 100 may also include at least one intermediate layer 130 disposed between the inner layer 110 and the outer layer 120. According to exemplary aspects of the invention, sealing characteristics of the bag 12 formed out of the composite film 100 may be improved. In addition, the composite film 100 may provide a barrier that efficiently blocks light, oxygen, and/or moisture from penetrating into the interior of the bag 12. Further, the toughness and the chemical compatibility of the bag 12 with the material stored therein may be improved. Still further, the shelf life of the material stored in the bag 12 formed out of the composite film 100 may be improved.

The inner layer 110 of the composite film 100 may be a coextruded film. The term “coextruded,” as used herein, may refer to a coextrusion process by which multiple materials are extruded together (e.g., simultaneously) such that the materials are maintained in separate layers in the final product. The coextrusion process may include feeding a plurality of materials together through a die (not shown) to form a single coextruded product (e.g., the coextruded film/inner layer 110), as would be readily understood by a person having ordinary skill in the art.

In addition, the term “coextruded,” as used herein in reference to a final product (e.g., the coextruded film/inner layer 110) that results from the coextrusion process, may be a generic description encompassing distinct structural characteristics imparted on the final product as a result of the coextrusion process. One such distinct structural characteristic of a coextruded product may be a unique adhesion/bond/tie between adjacent coextruded layers that results from the coextrusion process. Other distinct structural characteristics of a coextruded product may result from material interactions at the boundaries of different extruded materials, as would be readily understood by a person having ordinary skill in the art. Accordingly, the coextrusion process may be considered a manufacturing process that imparts distinctive structural characteristics to the final product whereby the final product can best be defined by the process (coextrusion) by which it is made. Thus, “coextruded,” as used herein in reference to a final product that results from a coextrusion process, may not only refer to the process by which the product is manufactured. Rather, the term “coextruded” in reference to a final product may also refer to distinctive characteristics imparted on the final product as a result of the coextrusion process. These distinctive characteristics may distinguish the product from other products comprised of similar materials.

The coextruded film (i.e., the inner layer 110), may include, in order from an inner side 100a of the composite film 100 to an outer side 100b of the composite film 100, a first layer 110a, a second layer 110b, a third layer 110c, a fourth layer 110d, and a fifth layer 110e. The first layer 110a and the fifth layer 110e may be made of at least one common material, such as a plastic material. The plastic material may be a polyethylene, and more particularly may be a linear low-density polyethylene. The linear low-density polyethylene may, for example, have a density between 0.915 and 0.925 g/cc. The first layer 110a and the fifth layer 110e may also be made of one or more additional materials. The additional materials may be common to both the first layer 110a and the fifth layer 110e, or may be unique to at least one of the first layer 110a and the fifth layer 110e. Alternatively, the first layer 110a and the fifth layer 110e may be made entirely of different materials. According to exemplary aspects of the invention, the first layer 110a and/or the fifth layer 110e may be constituent components of, for example, an improved barrier that may more efficiently block light, oxygen, and/or moisture from penetrating into the interior of the bag 12 formed from the composite film 100.

The second layer 110b and the fourth layer 110d may be made of at least one common material, such as a synthetic polymer. The synthetic polymer may be nylon. The second layer 110b and the fourth layer 110d may also be made of one or more additional materials. The additional materials may be common to both the second layer 110b and the fourth layer 110d, or may be unique to at least one of the second layer 110b and the fourth layer 110d. Alternatively, the second layer 110b and the fourth layer 110d may be made entirely of different materials. According to exemplary aspects of the invention, the second layer 110b and/or the fourth layer 110d may improve the strength and/or durability of the bag 12 formed from the composite film 100. Further, the second layer 110b and/or the fourth layer 110d may be constituent components of, for example, the improved barrier that may block chemical penetration into and out of the bag 12 formed from the composite film 100.

The third layer 110c may be made of ethylene vinyl alcohol, and may also be made of additional and/or alternative materials. According to exemplary aspects of the invention, the third layer 110c may further contribute to the chemical barrier provided by the composite film 100.

The outer layer 120 of the composite film 100 may be made of a plastic material. The plastic material may be a polyethylene, and more particularly may be a medium-density polyethylene. The medium-density polyethylene may have a density between 0.926 and 0.940 g/cc. The outer layer 120 may also be made of one or more additional materials. Further, the outer layer 120 may have design, emblem, insignia, etc. printed thereon. For example, the outer layer 120 may be transparent and may have a reverse-printed design provided on an inner surface of the outer layer 120 (i.e., a surface of the outer layer 120 that that faces the inner side 100a of the composite film 100) such that the design may be read by a user through the outer layer 120. The outer layer 120 may be adhered and/or laminated to an outer surface of the at least one intermediate layer 130 (i.e., a surface of the at least one intermediate layer 130 that faces the outer side 100b of the composite film 100) via an adhesive 140, such as a polyurethane. Additionally or alternatively, the adhesive may be a tie layer.

The at least one intermediate layer 130 may include a first intermediate layer 132 and a second intermediate layer 134. The first intermediate layer 132 may be disposed between the inner side 100a of the composite film 100 and the second intermediate layer 134. The first intermediate layer 132 may by a tie layer. That is, the first intermediate layer 132, the second intermediate layer 134, and the coextruded film (i.e., the inner layer 110) may be laminated together such that the first intermediate layer 132 ties the second intermediate layer 134 to the coextruded film. Further, as discussed above, the outer layer 120 may be laminated to an outer surface of the at least one intermediate layer 130, such as an outer surface of the second intermediate layer 134, via the adhesive 140. Accordingly, the outer layer 120, the adhesive 140, the first intermediate layer 132, the second intermediate layer 134, and the inner layer 110 may be laminated together to define the single composite film 100. The first intermediate layer 132 may be an adhesive, such as an ethylene acrylic acid copolymer. The first intermediate layer 132 may also be made of one or more additional materials. The first intermediate layer may have a thickness between 0.71 mm and 0.79 mm. For example, the thickness of the first intermediate layer may be 0.75 mm.

The second intermediate layer 134 may be a metal, such as aluminum. The second intermediate layer 134 may also be made of one or more additional materials. An outer surface of the second intermediate layer 134 and an inner surface of the outer layer 120 may be adhered via the adhesive 140. The second intermediate layer 134 may have a thickness between 0.27 mm and 0.30 mm. For example, the thickness of the first intermediate layer may be 0.285 mm. According to exemplary aspects of the invention, the second intermediate layer 134 may be a constituent component of, for example, the improved barrier provided by the composite film 100 that may more efficiently block light, oxygen, and/or moisture from penetrating into the interior of the bag 12 and may further contribute to the chemical barrier provided by the composite film 100.

The bag 12, as well as the bags used in the other exemplary dispenser embodiments of the invention described and/or incorporated herein, may be formed out of a flat composite film 100 that is formed into a tube bonded with overlapping edges. The bag(s) 12 may have openings that are bonded closed via adhesives, heat, sonic welding, and other techniques as would be readily understood by a person having ordinary skill in the art.

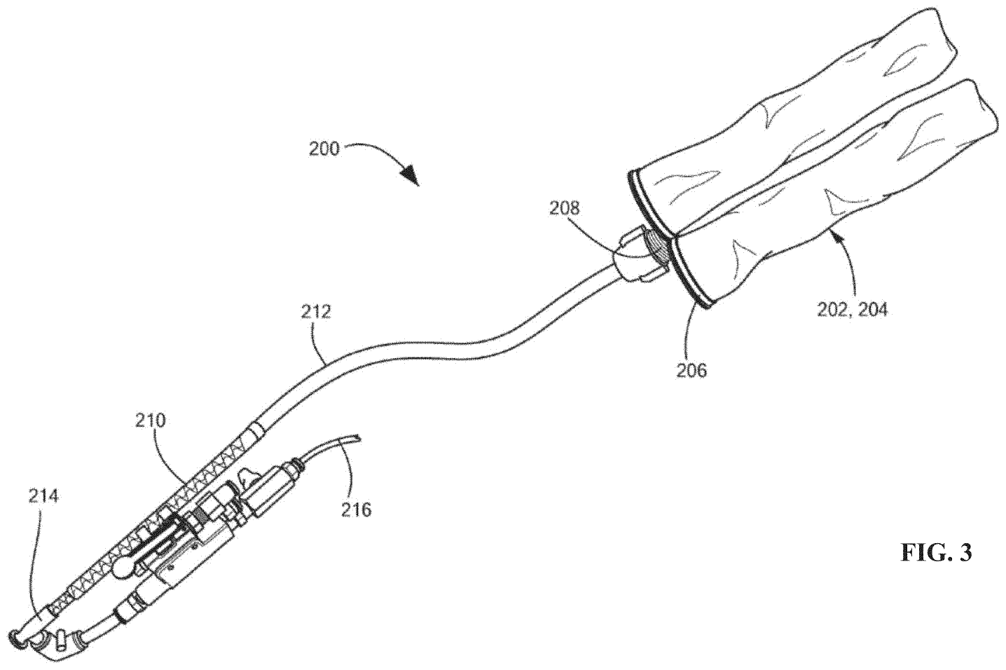

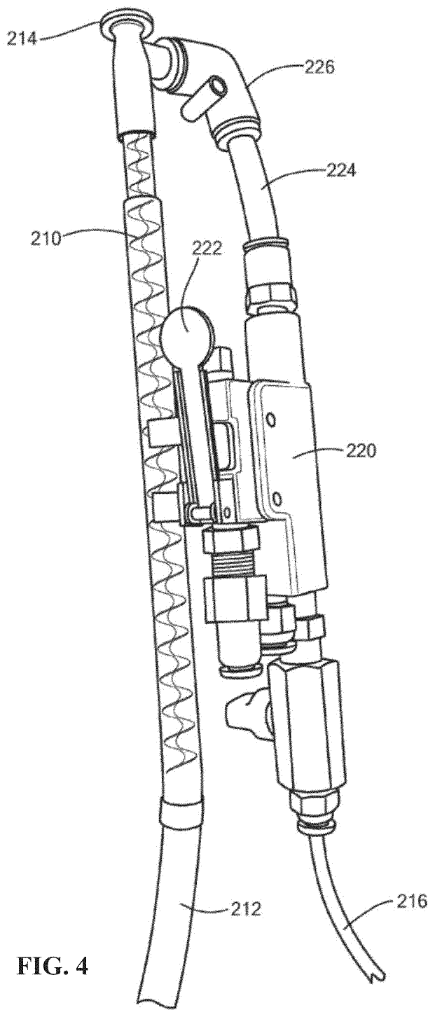

FIGS. 3 and 4 illustrate views of another exemplary dispenser 200 in accordance with aspects of the invention. FIG. 3 shows a side view of the dispenser 200. FIG. 4 shows a trigger assembly 220 of the dispenser 200. The dispenser 200 may include two flexible film pack bags 202, 204 (referred to herein as “film pack bags”). Though the exemplary dispenser 200 includes two flexible film pack bags 202, 204, the present invention is not limited to two film pack bags and may instead include only one film pack bag, or any suitable number of film pack bags required for the desired dispensing process. Any or both of the flexible film pack bags 202, 204 may be formed from a composite film (not shown). The composite film may be any of the embodiments of the composite film 100, described above.

The two flexible film pack bags 202, 204 may have a common rigid face plate 206 with a discharge nosepiece 208 that may be integrally formed with the face plate 206. The face plate 206 may further be integrally formed with a front end portion of the flexible film pack bags 202, 204, as described below. Further, the face plate 206 and the outer layer of the flexible film pack bags 202, 204 may have at least one common material, such as the plastic material of the outer layer 120 of the composite film 100, described above. The discharge nosepiece 208 may have a partition (not shown) internally disposed that may maintain separate flow streams from respective ones of the two flexible film pack bags 202, 204. Further, the discharge nosepiece 208 may have an outlet (not shown) disposed therethrough for dispensing the material.

The dispenser 200 may further include a mixer 210 in fluid communication with the two flexible film pack bags 202, 204. The mixer 210 may be provided on a downstream side of the two flexible film pack bags 202, 204. The fluid communication between the mixer 210 and the two flexible film pack bags 202, 204 may be effectuated via a first flexible tube 212 that may be disposed on an upstream side of the mixer 210. The flexible tube 212 may be a single tube that fluidly connects the mixer 210 to the discharge nosepiece 208 of the face plate 206. The flexible tube 212 may be of any length suitable for a purpose disclosed herein. For example, the length of the flexible tube 212 may be a length limited by a potting time of the two components from the two film pack bags 202, 204 as they travel, and partially mix while they travel, through the flexible tube 212. The dispenser 200 may also include a material applicator 214 (e.g., a spray tip) in fluid communication with, and provided on a downstream side of, the mixer 210. The dispenser 200 may also include a second flexible tube 216 in fluid communication with the material applicator 214. The second flexible tube 216 may supply atomized fluid (e.g., air) under pressure to the material applicator 214 from a supply (not shown).

The material from the film pack bags 202, 204 may be dispensed through the flexible tube 212, the mixer 210, and out the material applicator 214. The dispenser 200 may include a trigger assembly 220, as shown in FIG. 4, which may selectively provide the pressurized fluid from the flexible tube 216 to the material applicator 214. The trigger assembly 220 may include a trigger switch 222, a connecting tube 224, and a coupling 226. Actuation of the trigger switch 222 may permit the pressurized fluid to travel through the connecting tube 224 and the coupling 226 to provide atomization at the material applicator 214. Supply of atomized air, for example, to the material applicator 214 may facilitate spraying of the material in close quarters, such as below ground through a manhole cover.

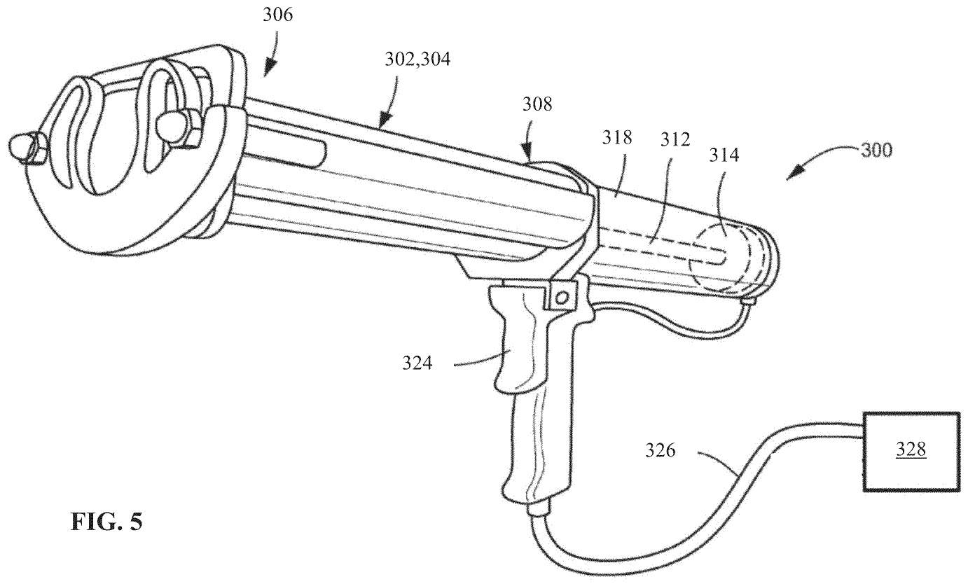

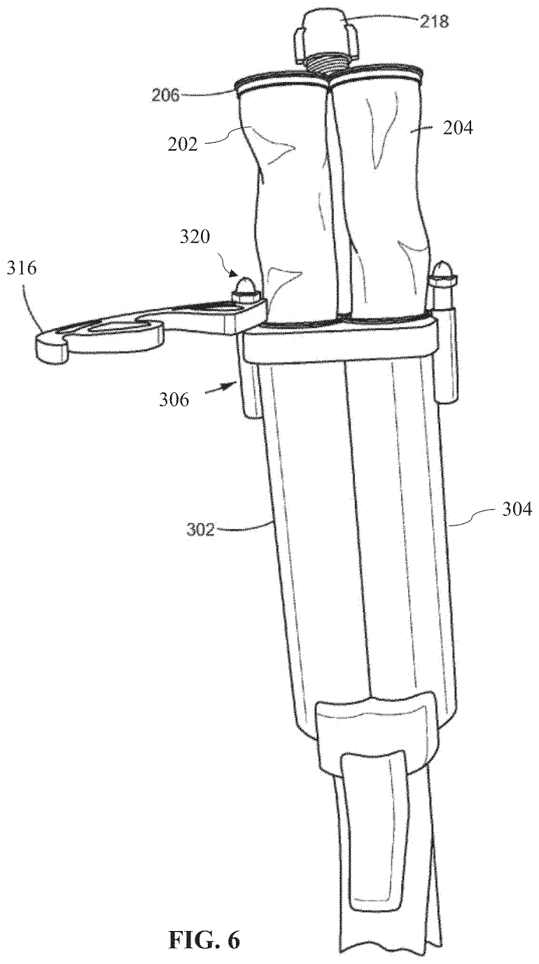

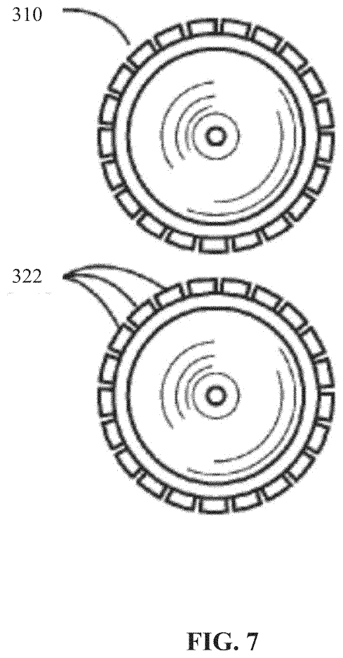

FIGS. 5-7 illustrate features of yet another dispenser 300 in accordance with aspects of the invention. FIG. 5 shows a perspective view of the dispenser 300. FIG. 6 shows the two flexible film pack bags 202, 204 being inserted into and received by cylindrical sleeves 302, 304 the dispenser 300. FIG. 7 shows shuttles 310 of the dispenser 300. The dispenser 300 may include the two flexible film pack bags 202, 204, as described above. Though the exemplary dispenser 300 includes two flexible film pack bags 202, 204, the present invention is not limited to two bags and may instead include only one bag, or any suitable number of bags required for the desired dispensing process. Any or both of the flexible film pack bags 202, 204 may be formed from a composite film (not shown). The composite film may be any of the embodiments of the composite film 100, described above.

The dispenser 300 may include two side-by-side sleeves 302, 304 each having a front end 306 and a back end 308. The two sleeves 302, 304 may be cylindrically shaped. The two cylindrical sleeves 302, 304 may have a higher rigidity than the flexible film bags, 202, 204, and may be of any material suitable for a purpose disclosed herein, such as aluminum, plastic, etc. As shown in FIG. 7, the dispenser 300 may also include two shuttles 310. The two shuttles 310 may be slidingly disposed internal of and proximate to the back end 308 of respective ones of the two cylindrical sleeves 302, 304. The dispenser 300 may also include two side-by-side push rods 312 that may be in operable communication with respective ones of the two shuttles 310. The dispenser 300 may further include a piston 314 that may be disposed in operable communication with the two push rods 312.

The dispenser 300 may further include a source 328 (e.g., an air compressor) of pressurized fluid (e.g., air) and a line 326 in fluid communication with the piston 314 and the source 328. The pressurized fluid supplied from the dispenser 300 through the line 326 may be utilized to drive the piston 314. The piston 314 may drive the push rods 312. The dispenser 300 may further include a trigger 324 that may be used to control flow of the pressurized fluid to the piston 314. The dispenser 300 may include a piston housing 318 that the two cylindrical sleeves 302, 304 may be fixedly attached to and that the piston 314 may be slidingly disposed within.

As shown in FIG. 6, the two flexible film pack bags 202, 204 may be inserted into and received by the front ends 306 of respective ones of the two cylindrical sleeves 302, 304. The dispenser 300 may also include a holder 316 that may be proximate the front end 306 of respective ones of the two cylindrical sleeves 302, 304. The holder 316 may restrain a face plate 206, fixed to ends of the two film pack bags 202, 204 (as discussed above), during dispensing of the material inside the two film pack bags 202, 204. The holder 316 may be secured to the two cylindrical sleeves 302, 304 via hardware 320. The holder 316 may be movable (e.g., pivotable) with respect to the two cylindrical sleeves 302, 304 to facilitate loading of the film pack bags 202, 204 into the two cylindrical sleeves 302, 304.

As shown in FIG. 7, each shuttle 310 may have a cylindrical disk shape, and may have a plurality of individual flexible fingers 322 disposed around the outer circumference of the respective shuttle 310. When the shuttles 310 are assembled into their respective sleeves 302, 304, the plurality of flexible fingers 322 of each shuttle 310 may flex radially inward in a non-sealing sliding engagement with an interior cylindrical surface of each respective sleeve 302. Spacing between adjacent ones of the flexible fingers 322 permits trapped air inside the sleeves 302, 304 (i.e., between the shuttles 310, sleeves 302, 304, and film pack bags 202, 204) to escape during a dispensing operation of the dispenser 300.

Additional and/or alternative features of the dispensers 200, 300 are described in U.S. patent application Ser. No. 15/361,681, published as U.S. Pub. No. 2017/0072426, the disclosure of which is hereby incorporated by reference herein in its entirety. U.S. patent application Ser. No. 15/361,681 also discloses a plurality of dispenser embodiments that utilize flexible bags, without a disclosure of forming the flexible bags out of the embodiments of the composite film 100 of the present invention. In accordance with aspects of the present invention, the dispenser embodiments disclosed in U.S. patent application Ser. No. 15/361,681 may also be formed from any of the embodiments of the composite film 100, described above. By forming the dispenser embodiments disclosed in U.S. patent application Ser. No. 15/361,681 from any of the embodiments of the composite film 100, described above, sealing characteristics of the bag may be improved. In addition, the composite film 100 may provide a barrier that efficiently blocks light, oxygen, and/or moisture from penetrating into the interior of the bag. Further, the toughness and the chemical compatibility of the bag with the material stored therein may be improved. Still further, the shelf life of the material stored in the bag formed out of the composite film 100 may be improved.

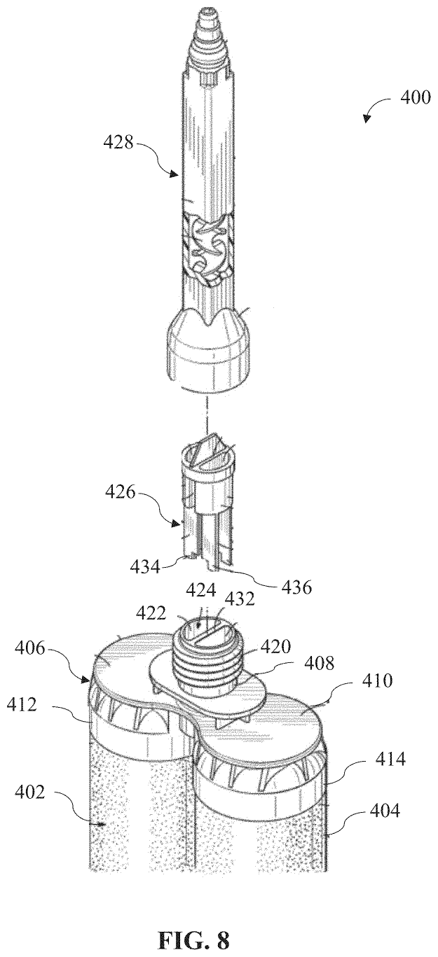

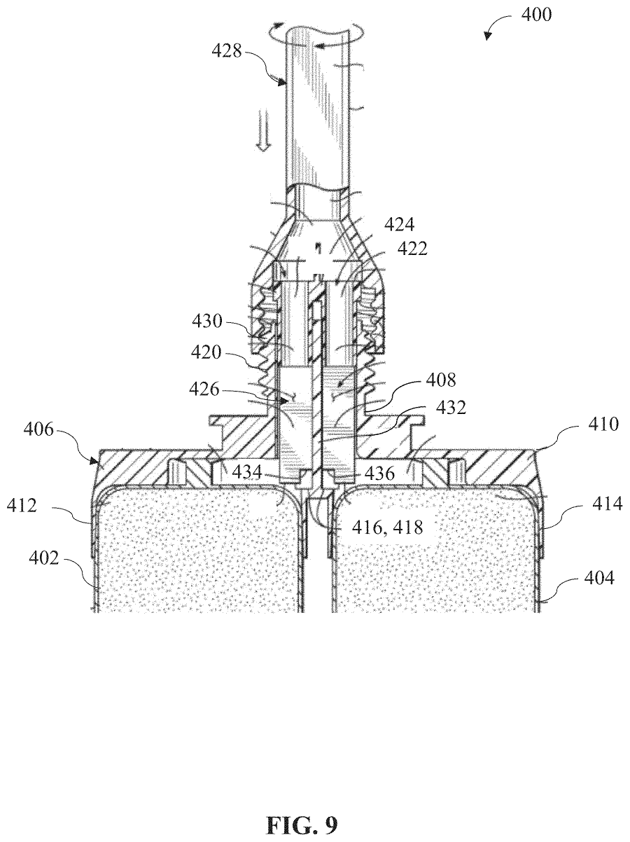

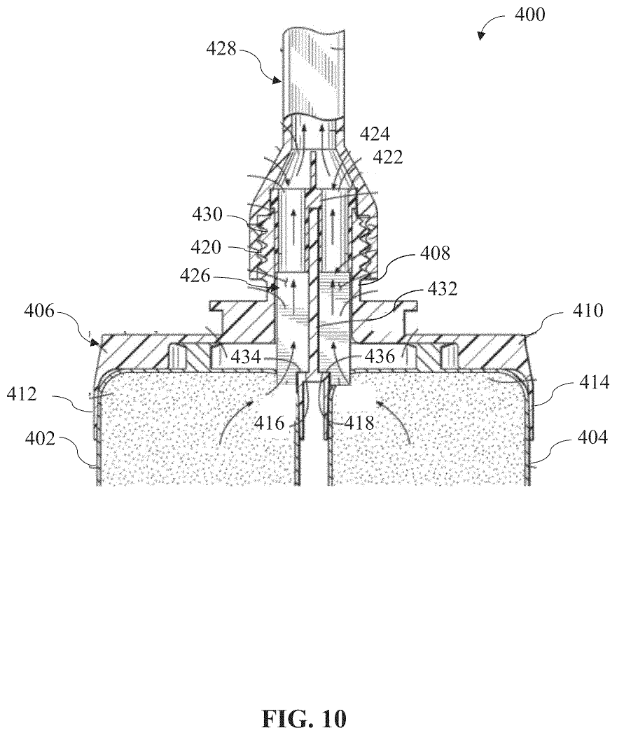

FIGS. 8-10 illustrate views of another dispenser 400 in accordance with aspects of the invention. FIG. 8 illustrates a perspective view of the dispenser 400. FIG. 9 illustrates a cross-sectional view of the dispenser 400 as the nozzle 428 is engaged with the face plate 406. FIG. 10 illustrates the cross-section view of FIG. 9 with the nozzle 428 fully engaged with the face plate 406. The dispenser 400 may include two flexible bags 402, 404 (referred to herein as “sausage pack bags”). Though the exemplary dispenser 400 includes two flexible sausage pack bags 402, 404, the present invention is not limited to two flexible sausage pack bags 402, 404 and may instead include only one sausage pack bag, or any suitable number of sausage pack bags required for the desired dispensing process. Any or both of the flexible sausage pack bags 202, 204 may be formed from a composite film (not shown). The composite film may be any of the embodiments of the composite film 100, described above.

The dispenser 400 may include a face plate 406 that may have a neck 408 and a cap section 410. The cap section 410 may include a first opening 412 and a second opening 414 that may receive and be coupled to the two flexible sausage pack bags 402, 404. The cap section 410 may further include a first shoulder 416 and a second shoulder 418. The first shoulder 416 and the second shoulder 418 may be positioned adjacent to the first opening 412 and the second opening 414, respectively. The neck 408 may include a threaded portion 420, an outlet 422, and/or a passageway 424. The passageway 424 may extend from the outlet 422 through the threaded portion 420, and to the first opening 412 and the second opening 414 such that the passageway 424 is in fluid communication with the cap section 410. As shown in FIGS. 9 and 10, the dispenser 400 may further include a piercer 426 that may slide within the passageway 424 of the neck 408 to pierce the two sausage pack bags 402, 404.

The dispenser 400 may further include a nozzle 428 that may have a threaded portion 430 that may engage with the threaded portion 420 of the neck 408 of the face plate 406. The neck 408 of the face plate 406 may include a partition 432 that may extend through the passageway 424 from the outlet 422 to the first shoulder 416 and the second shoulder 418 of the cap section 410. The piercer 426 may include a first step 434 and a second step 436 that may engage with the first shoulder 416 and the second shoulder 418, respectively, to limit sliding of the piercer 426 within the passageway 424. The nozzle 428 may engage the piercer 426 to cause the piercer 426 to slide within the passageway 424 of the neck 408 to pierce the two flexible sausage pack bags 402, 404 and therefore allow material disposed therein to flow through the passageway 424 and out the outlet 422 for dispensing though the nozzle 428. The nozzle 428 may cause the first step 434 and the second step 436 of the piercer 426 to be brought into respective engagement with the first shoulder 416 and the second shoulder 418 to terminate the sliding of the piercer 426 within the passageway 424.

Additional and/or alternative features of the dispenser 400 are described in U.S. Pat. No. 9,579,686, the disclosure of which is hereby incorporated by reference herein in its entirety. U.S. Pat. No. 9,579,686 also discloses a plurality of dispenser embodiments that utilize flexible bags, without a disclosure of forming the flexible bags out of the embodiments of the composite film 100 of the present invention. In accordance with aspects of the present invention, the dispenser embodiments disclosed in U.S. Pat. No. 9,579,686 may also be formed from any of the embodiments of the composite film 100, described above. By forming the dispenser embodiments disclosed in U.S. Pat. No. 9,579,686 from any of the embodiments of the composite film 100, described above, sealing characteristics of the bag may be improved. In addition, the composite film 100 may provide a barrier that efficiently blocks light, oxygen, and/or moisture from penetrating into the interior of the bag. Further, the toughness and the chemical compatibility of the bag with the material stored therein may be improved. Still further, the shelf life of the material stored in the bag formed out of the composite film 100 may be improved.

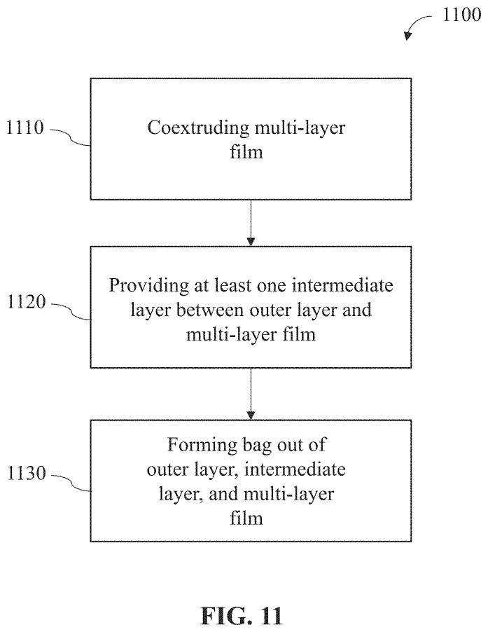

FIG. 11 illustrates a flow diagram of an exemplary process 1100 for producing a bag. The bag may be any of the bag(s) associated with dispensers 10, 200, 300, 400, or any of the other dispensers incorporated herein. The process 1100 may include, at step 1110, coextruding a multi-layer film. The coextruding of the multi-layer film may include the coextrusion of any combination of materials that would yield the resultant coextruded film of any embodiments of the inner layer 110 of the composite film 100, disclosed above.

At step 1120, the process 1100 may include providing at least one intermediate layer between an outer layer and the coextruded film. The at least one intermediate layer may include any of the embodiments of the at least one intermediate layer 130 of the composite film 100, disclosed above. The outer layer may be any of the embodiments of the outer layer 120, disclosed above. The process 1100 may further include adhering an outer surface of the at least one intermediate layer (e.g., an outer surface of the second intermediate layer 134) to the outer layer via an adhesive, such as a polyurethane.

Upon completion of the process 1100, at step 1130, the process 1100 may include forming the bag out of the outer layer, the at least one intermediate layer, and the coextruded film such that the outer layer defines an exterior of the bag and the coextruded film is an inner layer that defines an interior of the bag. The forming of the bag may include forming the bag into a tubular shape having a front end and a back end portion. The bag may be formed out of a flat composite film 100, according to any of the embodiments described above, which is formed into a tube bonded with overlapping edges. The process 1100 may include bonding openings of the bag to close the openings using adhesives, heat, sonic welding, and other techniques that would be readily understood by a person having ordinary skill in the art.

The process 1100 may also include connecting the bag to a dispenser, such as any of the dispensers described or incorporated herein. For example, the process 1100 may include mounting a front end portion of the bag on a mandrel. The process 1100 may further include inserting the mandrel and the front end portion into a mold and providing a cavity about an end of the mandrel and the front end portion of the bag. The process 1100 may also include injecting, into the cavity, molten synthetic resin of substantially the same composition as that of the outer layer (e.g., the outer layer 120) of the bag. The process 1100 may further include using heat of the molten synthetic resin to cause the outer layer of the front end portion of the bag to become molten and intermix with the molten synthetic resin to form a face plate of the apparatus sealingly overmolded on the front end portion of the bag. The face plate and the outer layer of the bag may be an integrated structure of essentially uniform composition having no distinct layers at an interface. The face plate may be formed with a discharge opening therein and a discharge nosepiece about the discharge opening aligned with the front end portion of the at least one bag. The bag may be disposed inwardly of the face plate.

The process 1100 may also include removing the face plate, the bag, and the mandrel from the cavity. The process 1100 may further include removing the bag and the face plate from the mandrel, and sealing the back end portion of the at least one bag.

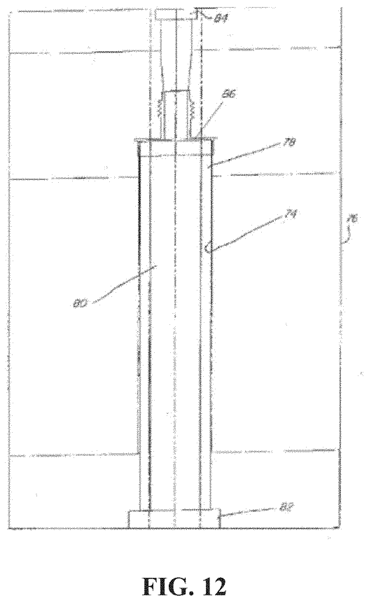

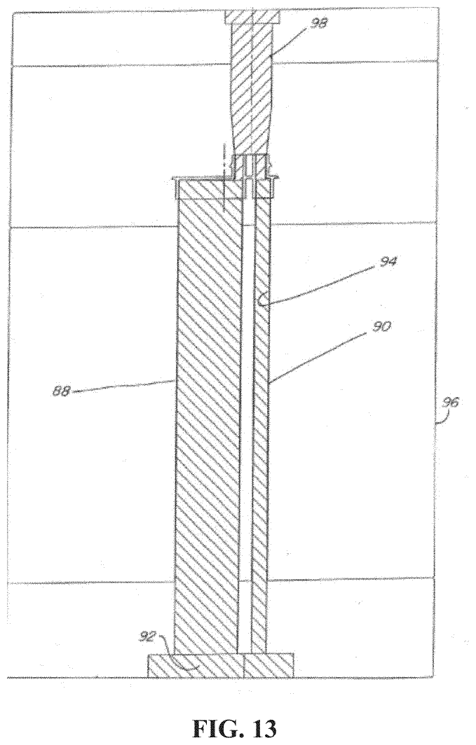

FIGS. 12 and 13 illustrate a schematic cross-sectional view of molds 76 and 96 for integrally molding a face plate of the dispenser to a bag, in accordance with aspects of the disclosure. FIG. 12 shows a schematic cross-sectional view of the mold 76. FIG. 13 shows a schematic cross-sectional view of the mold 96. The molds 76, 96 may, for example, be use to implement aspects of the process 1100 described above.

As shown in FIG. 12, seated in a complimentary cavity 74 in the mold 76 may be an annular mandrel 78 and a coaxial cylindrical mandrel 80 upon which the bag may be slidably supported. The mandrels 78, 80 may be supported on a base 82, and a secondary core 84 may extend downwardly to cooperate with the mandrels 78, 80 to provide a cavity portion 86 corresponding to a desired configuration for a face plate.

Molten synthetic resin may be injected into the cavity portion 86 through runners (not shown) to produce the desired face plate. The molten resin may heat the outer layer of exposed end portions of the bag to effectuate a strong bond between the bag and face plate, as described above. After cooling, the mold 76 may be opened and the mandrel fixture may be withdrawn. The bag may be slid off the mandrels 78, 80 and the opposite ends of the film bags may be sealed to provide an empty bag.

As shown in FIG. 13, another mold 96 may be provided with a large diameter mandrel 88 and a small diameter mandrel 90, which may be supported on a base 92. The bag may be supported on the mandrels 88, 90 in a mold cavity 94 of the mold 96. A secondary core 98 may cooperate with the mold cavity 94 to provide a cavity portion in which the ends of the film bags 52, 54 may be exposed so that resin may flow thereabout to form a face plate and bond components. After cooling, the mandrel assembly may be withdrawn from the mold 96 and the face plate and film bags may be removed therefrom to provide the empty bag.

While the aspects of the invention have been described in connection with the various embodiments of the various figures, it is to be understood that other similar embodiments can be used or modifications and additions can be made to the described embodiments. Therefore, the methods and systems as described herein should not be limited to any single embodiment, but rather should be construed in breadth and scope in accordance with the appended claims.

What is claimed is:

1. An apparatus for dispensing a flowable material, the apparatus comprising:
at least one bag, the at least one bag comprising:
an inner layer that is a coextruded film and that defines an interior of the at least one bag configured to contain the flowable material;
an outer layer that defines an exterior of the at least one bag; and
at least one intermediate layer disposed between the inner and outer layers; and
a face plate having an outlet configured to be placed in fluid communication with the interior of the at least one bag, wherein the flowable material is configured to flow from the interior of the at least one bag to be dispensed from the outlet of the face plate.

2. The apparatus of claim 1, wherein the coextruded film includes, in order, a first layer, a second layer, a third layer, a fourth layer, and a fifth layer.

3. The apparatus of claim 2, wherein the first and fifth layers each comprise a plastic.

4. The apparatus of claim 3, wherein the plastic is a polyethylene.

5. The apparatus of claim 4, wherein the polyethylene is a linear low-density polyethylene with a density between 0.915 and 0.925 g/cc.

6. The apparatus of claim 2, wherein the second and fourth layers each comprise a synthetic polymer.

7. The apparatus of claim 6, wherein the synthetic polymer is nylon.

8. The apparatus of claim 2, wherein the third layer comprises ethylene vinyl alcohol.

9. The apparatus of claim 2, wherein
the first and fifth layers each comprise a linear low-density polyethylene,
the second and fourth layers each comprise nylon, and
the third layer comprises ethylene vinyl alcohol.

10. The apparatus of claim 9, wherein the outer layer comprises a plastic.

11. The apparatus of claim 10, wherein the plastic is a polyethylene.

12. The apparatus of claim 11, wherein the polyethylene is a medium-density polyethylene with a density between 0.926 and 0.940 g/cc.

13. The apparatus of claim 1, wherein the at least one intermediate layer includes a first intermediate layer and a second intermediate layer.

14. The apparatus of claim 13, wherein the first intermediate layer is a tie layer and the first intermediate layer, the second intermediate layer, and the coextruded film are laminated together such that the first intermediate layer ties the second intermediate layer to the coextruded film.

15. The apparatus of claim 14, wherein the first intermediate layer comprises an adhesive.

16. The apparatus of claim 15, wherein the adhesive is an ethylene acrylic acid copolymer.

17. The apparatus of claim 13, wherein the second intermediate layer comprises a metal.

18. The apparatus of claim 17, wherein the metal is aluminum.

19. The apparatus of claim 13, wherein the outer layer is adhered to an outer surface of the second intermediate layer via an adhesive.

20. The apparatus of claim 19, wherein the adhesive is a polyurethane.

21. The apparatus of claim 1, further comprising:
at least one sleeve having a front end portion and a back end portion;
at least one shuttle slidingly disposed internal of and proximate to the back end portion of the at least one sleeve;
at least one push rod disposed in operable communication with the at least one shuttle;
at least one piston disposed in operable communication with the at least one push rod, the at least one piston configured to drive the at least one push rod; and
a holder disposed proximate the front end portion of the at least one sleeve, the holder configured to restrain the face plate during dispensing of the flowable material, wherein
the at least one bag is a flexible film pack bag that is disposed within the at least one sleeve,
the face plate is rigid and is integrally formed on a front end portion of the flexible film pack bag,
the face plate has a discharge nosepiece integrally formed therewith,
the face plate and the outer layer of the flexible film pack bag each comprise at least one common material, and
the discharge nosepiece has the outlet disposed therethrough.

22. The apparatus of claim 21, wherein the at least one shuttle has a circumference and a plurality of individual flexible fingers disposed around the circumference in sliding engagement with an interior surface of the at least one sleeve.

23. The apparatus of claim 21, further comprising:
a mixer configured to be in fluid communication with and on a downstream side of the at least one bag; and
a first flexible tube disposed in fluid communication with and on an upstream side of the mixer, and in fluid communication with the discharge nosepiece.

24. The apparatus of claim 1, wherein
the face plate includes a neck and a cap section,
the cap section comprises an opening configured to receive and be coupled to the at least one bag, and at least one shoulder positioned adjacent to the opening, and
the neck comprises a passageway extending from the outlet to the opening such that the passageway is in fluid communication with the cap section.

25. The apparatus of claim 24, wherein:
the neck of the face plate further includes a partition that extends through the passageway from the outlet to the at least one shoulder,
the piercer includes at least one step that is configured to engage with the at least one shoulder to limit sliding of the piercer within the passageway, and
the nozzle is configured to engage the piercer and to cause the piercer to slide within the passageway of the neck to pierce the at least one bag and to bring the at least one step of the piercer into engagement with the at least one shoulder to terminate the sliding of the piercer within the passageway.

26. A method of producing at least one bag of an apparatus for dispensing a flowable material, the method comprising:
coextruding a film;
providing at least one intermediate layer between an outer layer and the coextruded film; and
forming the at least one bag out of the outer layer, the at least one intermediate layer, and the coextruded film such that the outer layer defines an exterior of the at least one bag and the coextruded film is an inner layer that defines an interior of the at least one bag.

27. The method of claim 26, wherein the coextruded film includes, in order, a first layer, a second layer, a third layer, a fourth layer, and a fifth layer.

28. The method of claim 27, wherein the first and fifth layers each comprise a plastic.

29. The method of claim 28, wherein the plastic is a polyethylene.

30. The method of claim 29, wherein the polyethylene is a linear low-density polyethylene with a density between 0.915 and 0.925 g/cc.

31. The method of claim 27, wherein the second and fourth layers each comprise a synthetic polymer.

32. The method of claim 31, wherein the synthetic polymer is nylon.

33. The method of claim 27, wherein the third layer comprises ethylene vinyl alcohol.

34. The method of claim 27, wherein
the first and fifth layers each comprise a linear low-density polyethylene,
the second and fourth layers each comprise nylon, and
the third layer comprises ethylene vinyl alcohol.

35. The method of claim 34, wherein the outer layer comprises a plastic.

36. The method of claim 35, wherein the plastic is a polyethylene.

37. The method of claim 36, wherein the polyethylene is a medium-density polyethylene with a density between 0.926 and 0.940 g/cc.

38. The method of claim 26, wherein the at least one intermediate layer includes a tie layer and a second intermediate layer, the method further comprising laminating the tie layer, the second intermediate layer, and the coextruded film together such that the tie layer ties the second intermediate layer to the coextruded film.

39. The method of claim 38, wherein the tie layer comprises an adhesive.

40. The method of claim 39, wherein the adhesive is an ethylene acrylic acid copolymer.

41. The method of claim 38, wherein the second intermediate layer comprises a metal.

42. The method of claim 41, wherein the metal is aluminum.

43. The method of claim 26, wherein forming the at least one bag includes forming the at least one bag into a tubular shape having a front end portion and a back end portion.

44. The method of claim 43, further comprising:
mounting the front end portion of the at least one bag on a mandrel;
inserting the mandrel and the at least one bag into a mold providing a cavity about an end of the mandrel and the front end portion of the at least one bag;
injecting, into the cavity, molten synthetic resin of substantially the same composition as that of the outer layer of the at least one bag, melting the front end portion of the at least one bag using heat of the molten synthetic resin to cause the outer layer of the front end portion of the at least one bag to become molten and intermix with the molten synthetic resin to form a face plate of the apparatus sealingly overmolded on the front end portion of the at least one bag, the face plate and the outer layer of the at least one bag being an integrated structure of essentially uniform composition having no distinct layers at an interface, the face plate having a discharge opening therein and a discharge nosepiece about the discharge opening aligned with the front end portion of the at least one bag, the at least one bag being disposed inwardly of the face plate;
removing the face plate, the at least one bag, and the mandrel from the cavity;
removing the at least one bag and the face plate from the mandrel; and
sealing the back end portion of the at least one bag.
